(19) United States
(12) Patent Application Publication
(10) Pub. No.: US 2026/0270079 A1
(43) Pub. Date: Sep. 10, 2026

(54) Intelligent Systems and Methods to Securely Store Collateral Information

(71) Applicant: Bank of America Corporation, Charlotte, NC (US)

(72) Inventors: Divya Nagarajan, Chennai (IN); Meenu Goyal, Punjab (IN); Pinky Panwar, Gujrat (IN); Durga Prasad Kuthumolu, Hyderabnad (IN)

(21) Appl. No.: 19/069,441

(22) Filed: Mar. 4, 2025

(51) Int. Cl. H04L 9/32; G06F 21/16; H04L 9/00

(52) U.S. Cl. CPC H04L 9/3247; G06F 21/16; H04L 9/3213; H04L 9/50

(57) ABSTRACT

Arrangements for securely storing collateral information associated with an electronic document are provided. A computing platform may receive a document that represents a collateral asset. The computing platform may scan the document to identify text in the document. The computing platform may slice the scanned document into one or more slices. The computing platform may apply a watermarking process to the scanned document and the one or more slices. The computing platform may add, after the watermarking process, the scanner document and the one or more slices to a blockchain environment. The computing platform may send a confirmation that indicates that the scanned document and the one or more slices were added to the blockchain environment.

### BACKGROUND

An electronic document that represents an asset may be used as collateral for any number of reasons, such as securing a loan. Issues may arise with respect to securely storing the electronic document and collateral information associated with the electronic document. Further, maintaining an accurate electronic record of ownership associated with the electronic document for verification purposes may present security challenges. Accordingly, it may be advantageous to identify more effective and efficient methods to securely store electronic documents.

### SUMMARY

Aspects of the disclosure provide effective, efficient, scalable, and convenient solutions that address and overcome the technical problems associated with secure storage and control of access to electronic documents. In accordance with one or more aspects of the disclosure, a computing platform with at least one processor, a communication interface communicatively coupled to the at least one processor, and memory storing computer-readable instructions may receive a document from a computing device, in which the document may represent a collateral asset. The computing platform may scan the document to identify text in the document using an optical character recognition technique. The computing platform may slice the scanned document into one or more slices that may correspond to one or more sub-portions of the identified text in the document. The computing platform may apply a watermarking process to the scanned document and the one or more slices, which may embed an anti-tamper digital signature to the scanned document and the one or more slices. The computing platform may add, after the watermarking process, the scanned document and the one or more slices to a blockchain environment. The computing platform may send a confirmation to the computing device that may indicate that the scanned document and the one or more slices were added to the blockchain environment.

In one or more examples, the computing platform may configure a dynamic non-fungible token (DNFT) to process requests for access to the scanned document or the one or more slices. In some instances, the scanning may further include preprocessing the document, detecting text in the document, localizing the text that was detected, and classifying the text based on one or more classification rules.

In one or more examples, the applying the watermarking process may further include performing a compression process to compress and encrypt the scanned document and the one or more slices, performing a feature watermarking process to create a feature watermark for the scanned document and the one or more slices, performing an actual watermarking process to create an actual watermark for the scanned document and the one or more slices, and combining the feature watermark and the actual watermark to create a final watermark for the scanned document and the one or more slices.

In some instances, the blockchain environment may further include a mainchain and one or more sidechains. In one or more examples, the scanned document may be stored on the mainchain and the one or more slices may be stored in the one or more sidechains.

In some instances, the configuring the DNFT may further include configuring smart contract logic that is used to verify a request for access to the document or the one or more slices of the document, configuring information extraction logic that is used to identify a location of information associated with the requested, and configuring an interface to display information that was requested.

In one or more examples, the computing platform may receive a change indication that may indicate either a document update or a permission update. In some instances, the computing platform may, based on the change indication being the document update, re-perform the scanning, the slicing, the applying, and the adding using the updated document. In one or more examples, the computing platform may, based on the change indication being a permission update, update one or more permission levels to access the scanned document or the one or more slices based on the permission update.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1D depict an illustrative computing environment for securely storing and requesting collateral information in accordance with one or more example aspects described herein;

FIGS. 2A-2D depict an illustrative event sequence for securely storing and requesting collateral information in accordance with one or more example aspects described herein;

FIGS. 3-8 depict illustrative methods for securely storing and requesting collateral information in accordance with one or more example aspects described herein; and

FIG. 9 depicts an illustrative graphical user interface for securely storing and requesting collateral information in accordance with one or more example aspects described herein.

### DETAILED DESCRIPTION

In the following description of various illustrative aspects, reference is made to the accompanying drawings, which form a part hereof, and in which is shown, by way of illustration, various aspects in which aspects of the disclosure may be practiced. In some instances, other aspects may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to securely storing and validating requests for collateral information. Currently, managing risk with respect to storing and accessing information associated with a collateral asset may be complex and introduce security issues. As such, utilizing a secure storage and tracking system for information associated with a collateral asset may help ensure the integrity of collateral assets.

A few example scenarios highlighting security issues may be as follows. These example scenarios may be related to unauthorized acquisition of or access to collateral. First, unauthorized collateral transfer, in which an employee with access to the collateral may record at an institution a transfer of the collateral to an unauthorized account or entity. Second, lack of collateral verification, in which an institution may fail to conduct proper due diligence on collateral assets offered by borrowers. Third, unauthorized acquisition of collateral, in which a customer's valuable assets held as collateral may disappear from a storage facility of the institution (e.g., that is storing the asset). Fourth, loan office issues, in which a loan officer at an institution is discovered to have approved loans using inflated collateral valuations, keeping the difference.

Accordingly, described herein is a system that may utilize multi-layer security features with respect to storing and accessing information associated with a collateral asset. For example, the system may utilize granular data classification of the information associated with the collateral asset. In some cases, optical character recognition may be performed to interpret and/or classify the collateral information on a document that represents the collateral asset. Further, the system may slice pieces of the collateral information based on the previously performed data classification. Then, a watermarking process may be applied to the entire document as well as the sliced information. This process may enable unique hash values associated with the watermarked information to be created, which in turn may be used in part to add one or more blocks to a mainchain blockchain and one or more sidechain blockchains, on a distributed blockchain network. The mainchain may store the entire document while sidechains may be used to store the sliced information.

Accordingly, the system may configure a dynamic non-fungible token (DNFT), using, for example, a combination of smart contract logic and information extraction logic. The smart contract logic may be used to define one or more permission levels that may be used to allow access to one or more individuals and/or entities to request access to the collateral information stored in the distributed blockchain network. The information extraction logic may be used to locate and extract the requested collateral information stored on the blockchain network. In this manner, the DNFT may be activated based on a request for collateral information, to deliver portions of the requested collateral information to the requestor.

These and other features are described in greater detail below.

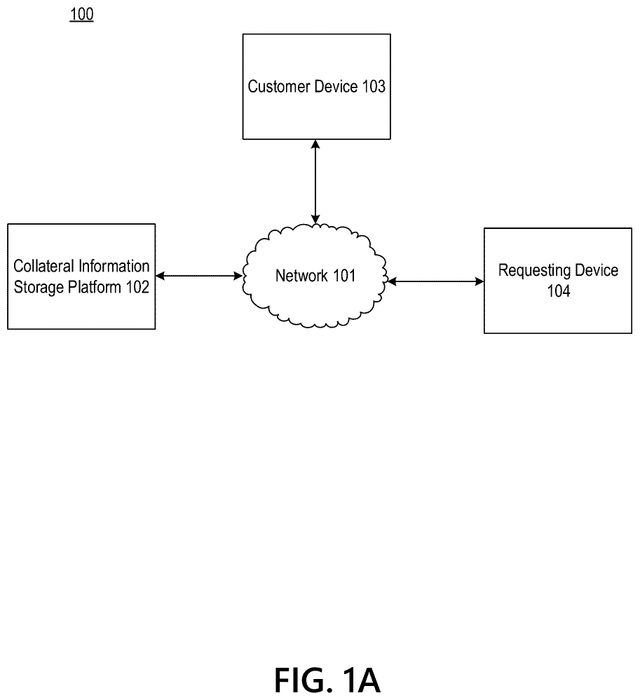

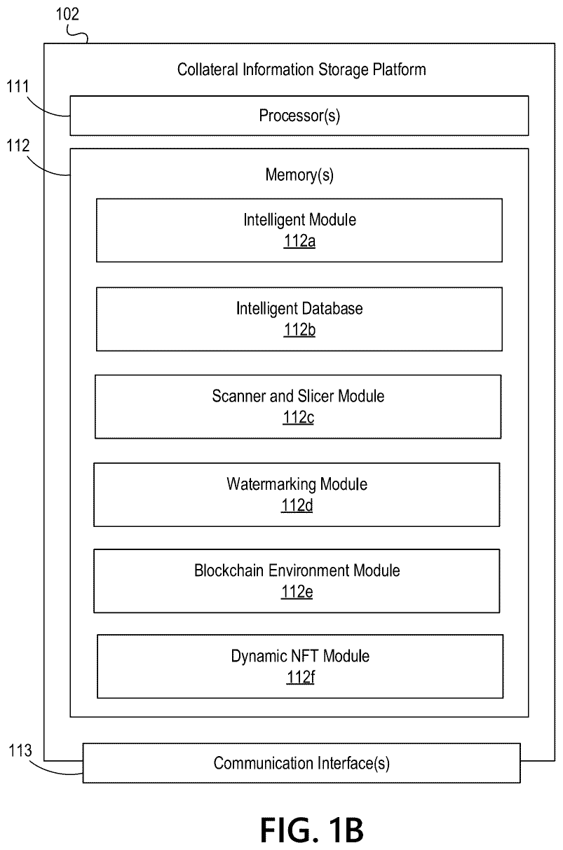

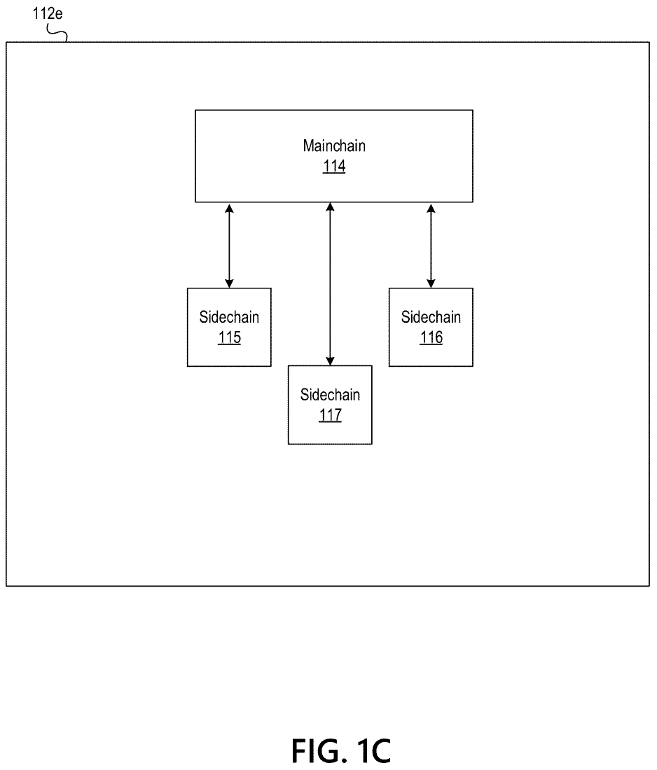

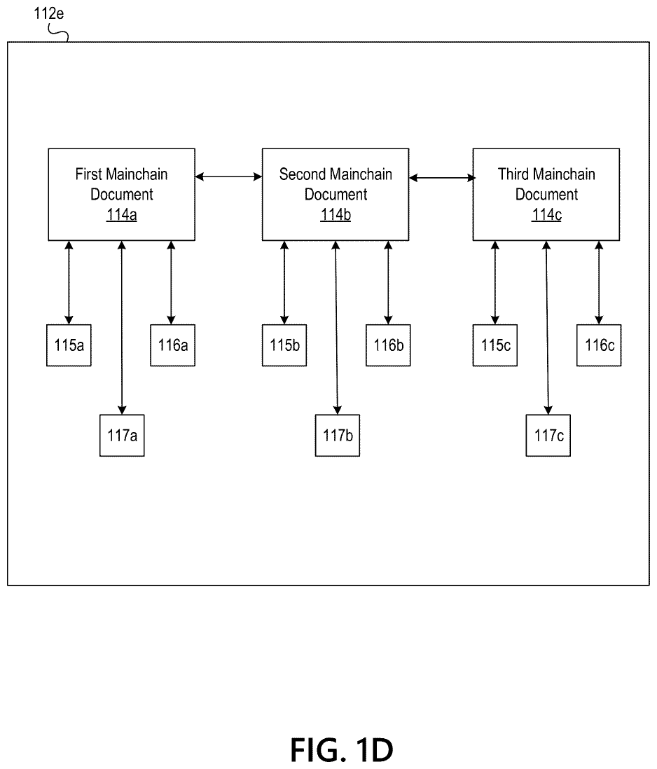

FIGS. 1A-1D depict an illustrative computing environment for securely storing and requesting collateral information in accordance with one or more example aspects. Referring to FIG. 1A, computing environment 100 may include one or more computer systems. For example, computing environment 100 may include a collateral information storage platform 102, customer device 103, and requesting device 104.

As described further below, collateral information storage platform 102 may be a computer system that includes one or more computing devices (e.g., servers, server blades, or the like) and/or other computer components (e.g., processors, memories, communication interfaces) that may be used to receive a document (i.e., a collateral asset) from customer device 103, scan the document, slice the document according to one or more preconfigured classification rules, apply a watermarking process to the document and slices of the document, store the watermarked information in a blockchain environment, validate requests for collateral information from a requesting device 104, and/or perform other functions.

Customer device 103 may be a laptop computer, desktop computer, mobile device, tablet, smartphone, and/or other device, which may correspond to an owner of a document that represents a collateral asset (e.g., a deed to a house). In some instances, customer device 103 may be a computing device that is used by an individual. In some instances, customer device 103 may be a computing device that is used by an entity that owns the underlying collateral asset.

Requesting device 104 may be a laptop computer, desktop computer, mobile device, tablet, smartphone, and/or other device, which may correspond to an entity that may wish to request access to collateral information associated with the collateral asset. In some instances, requesting device 104 may have a level of permission that enables access to all or some of the collateral information. In some instances, requesting device 104 may be configured to display one or more interfaces (e.g., interfaces depicting collateral information that has been requested and extracted from a blockchain network, or the like).

Computing environment 100 also may include one or more networks, which may include collateral information storage platform 102, customer device 103, and requesting device 104. For example, computing environment 100 may include a network 101 (which may interconnect, e.g., collateral information storage platform 102, customer device 103, and requesting device 104, and/or other computing devices).

In one or more arrangements, collateral information storage platform 102, customer device 103, and requesting device 104 may be any type of computing device capable of sending and/or receiving requests and processing the requests accordingly. For example, collateral information storage platform 102, customer device 103, and requesting device 104, and/or the other systems included in computing environment 100 may, in some instances, be and/or include, server computers, desktop computers, laptop computers, tablet computers, smart phones, or the like that may include one or more processors, memories, communication interfaces, storage devices, and/or other components. As noted above, and as illustrated in greater detail below, any and/or all of collateral information storage platform 102, customer device 103, and requesting device 104 may, in some instances, be special-purpose computing devices configured to perform specific functions.

Referring to FIG. 1B, collateral information storage platform 102 may include one or more processors 111, memory 112, and communication interface 113. A data bus may interconnect processor 111, memory 112, and communication interface 113. Communication interface 113 may be a network interface configured to support communication between collateral information storage platform 102 and one or more networks (e.g., network 101, or the like). Memory 112 may include one or more program modules having instructions that when executed by processor 111 cause collateral information storage platform 102 to perform one or more functions described herein and/or one or more databases that may store and/or otherwise maintain information which may be used by such program modules and/or processor 111. In some instances, the one or more program modules and/or databases may be stored by and/or maintained in different memory units of collateral information storage platform 102, customer device 103, and requesting device 104, and/or by different computing devices that may form and/or otherwise make up collateral information storage platform 102, customer device 103, and requesting device 104.

For example, memory 112 may have, host, store, and/or otherwise include intelligent module 112a, intelligent database 112b, scanner and slicer module 112c, watermarking module 112d, blockchain environment module 112e, and dynamic NFT module 112f. Intelligent module 112a may have instructions that direct and/or cause collateral information storage platform 102 to receive a document from customer device 103, process the document, receive a request from requesting device 104 to access collateral information associated with the document, process the request, and/or perform other functions. Intelligent database 112b may store information used by the intelligent module 112a and/or collateral information storage platform 102 in application of techniques to securely store and/or access collateral information, and/or perform other functions. Scanner and slicer module 112c may be configured and/or used by collateral information storage platform 102 and/or intelligent module 112a to scan a document, slice the document into sub-portions according to one or more classification rules, and/or perform other functions. Watermarking module 112d may be configured and/or used by collateral information storage platform 102 to apply a watermarking process to the document and/or slices of the document, and/or perform other functions. Blockchain environment module 112e may be configured and/or used by collateral information storage platform 102 to host, maintain, and/or otherwise modify a distributed blockchain network that may store the document and slices of the document using a mainchain and one or more sidechains, and/or perform other functions. Dynamic NFT module 112f may be configured and/or used by collateral information storage platform 102 to process and/or verify a request from requesting device 104 for access to collateral information associated with the document (e.g., the collateral asset), and/or perform other functions.

Referring to FIG. 1C, blockchain environment module 112e may include a mainchain 114, sidechain 115, sidechain 116, and/or sidechain 117. Further, blockchain environment module 112e may host a distributed blockchain environment (i.e., one or more blockchain networks that are cryptographically linked to each other) that includes the mainchain (e.g., mainchain 114) and one or more sidechains (e.g., sidechain 115, sidechain 116, and sidechain 117). Mainchain 114 may be the blockchain network in which an entire document may be stored (i.e., the document that represents the collateral asset). Sidechain 115, sidechain 116, and sidechain 117 may each be blockchain networks that are used to store sub-portions (i.e., slices) of a document based on one or more preconfigured classification rules related to the sub-portion of information from the document that is sliced.

For example, sidechain 115 may be configured to store a slice of a document that corresponds to a name of an owner of the underlying collateral asset associated with the document. As another example, sidechain 116 may be configured to store a slice of a document that corresponds to a date in which the owner of the underlying asset associated with the document acquired the asset. In yet another example, sidechain 117 may be configured to store a slice of a document that corresponds to a confirmation number associated with the underlying collateral asset. Although three different examples of types of information that are stored in either of sidechains 115-117 are given, additional or fewer sidechains may be used to store similar information without departing from the scope of the disclosure.

FIG. 1D illustrates another layer of detail with respect to the blockchain environment module 112e that was described with reference to FIG. 1C. As shown by FIG. 1D, blockchain environment module 112e may include first mainchain document 114a, second mainchain document 114b, and third mainchain document 114c. Each of first mainchain document 114a, second mainchain document 114b, and third mainchain document 114c may represent a corresponding document from one or more users (i.e., a different collateral asset for each individual user). Each of first mainchain document 114a, second mainchain document 114b, and third mainchain document 114c may be stored in the mainchain 114 that was described with reference to FIG. 1C.

FIG. 1D also shows 115a, 115b, and 115c, which may be slices of each respective document (i.e., 115a is a slice of first mainchain document 114a, 115b is a slice of second mainchain document 114b, 115c is a slice of third mainchain document 114c) that are stored in sidechain 115. Sidechain 115, for example, may store collateral information such as a name of an owner of the underlying collateral asset associated with each document. Slices 116a, 116b, and 116c may be slices of each respective document (i.e., 116a is a slice of first mainchain document 114a, 116b is a slice of second mainchain document 114b, 116c is a slice of third mainchain document 114c) that are stored in sidechain 116. Sidechain 116, for example, may store collateral information such as a date in which the owner of the underlying asset associated with the document acquired the asset. Slices 117a, 117b, and 117c may be slices of each respective document (i.e., 117a is a slice of first mainchain document 114a, 117b is a slice of second mainchain document 114b, 117c is a slice of third mainchain document 114c) that are stored in sidechain 117. Sidechain 117, for example, may store collateral information such as a confirmation number associated with the underlying collateral asset.

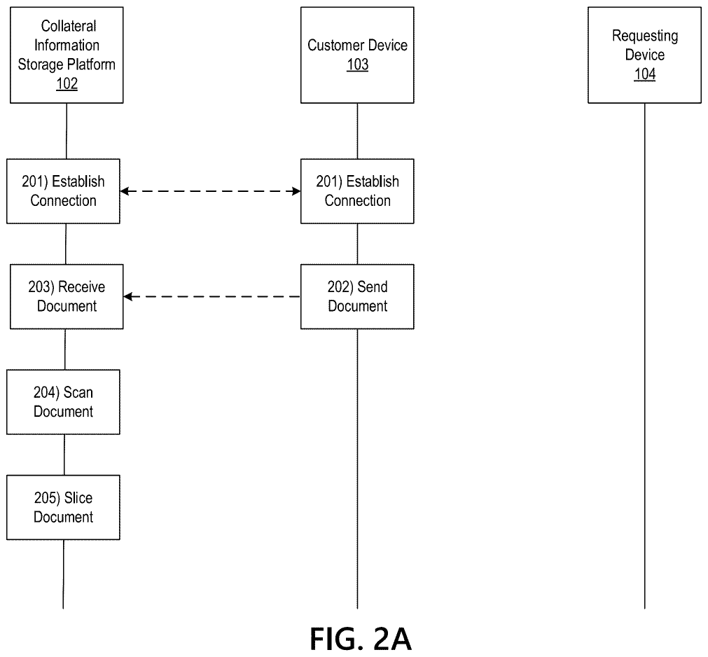

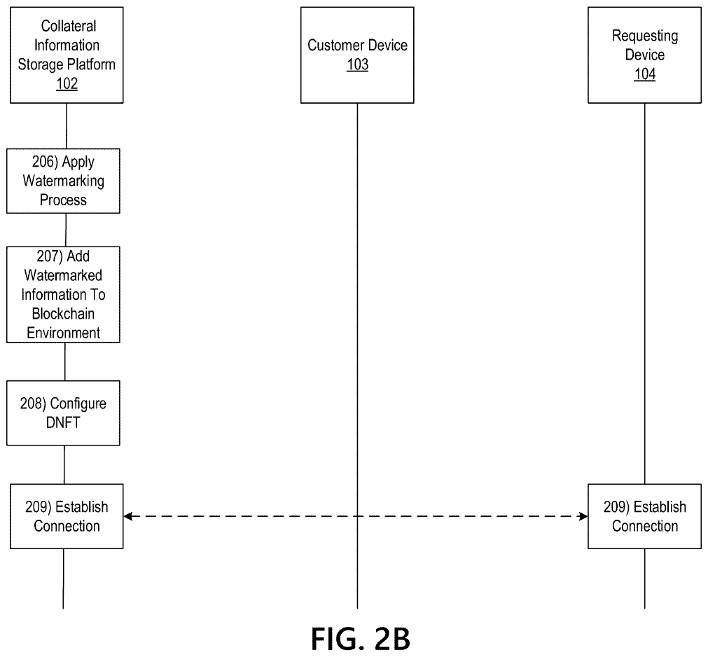

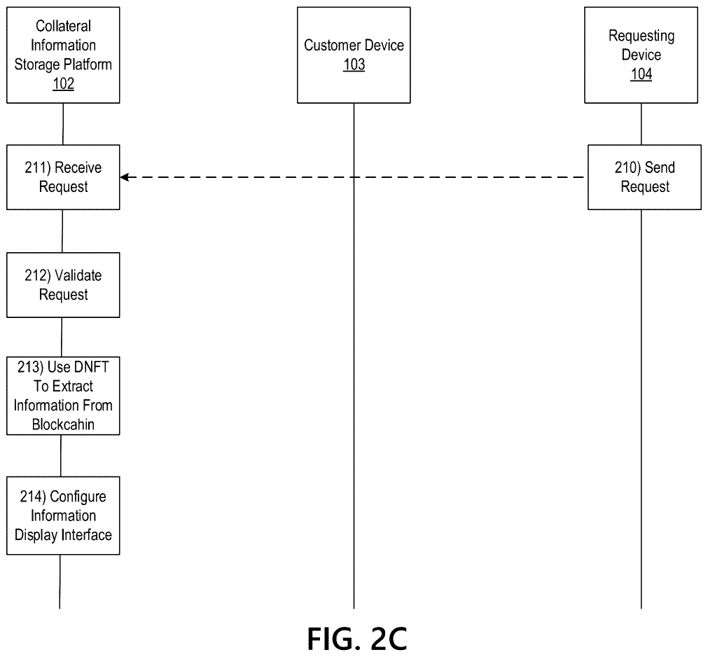

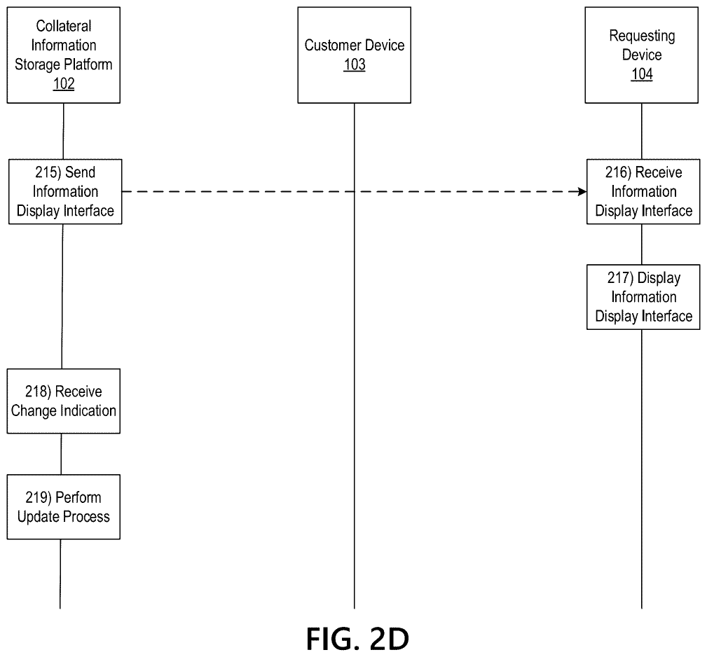

FIGS. 2A-2D depict an illustrative event sequence for securely storing and requesting collateral information in accordance with one or more example aspects described herein. Referring to FIG. 2A, at step 201, customer device 103 may establish a connection with collateral information storage platform 102. For example, customer device 103 may establish a first wireless data connection with collateral information storage platform 102 to link customer device 103 to collateral information storage platform 102 (e.g., in preparation for sending an electronic document that represents a collateral asset). In some instances, customer device 103 may identify whether or not a connection is already established with collateral information storage platform 102. If a connection is already established with collateral information storage platform 102, customer device 103 might not re-establish the connection. If a connection is not already established with collateral information storage platform 102, customer device 103 may establish the first wireless data connection as described herein.

At step 202, customer device 103 may send a document (i.e., an electronic document) to collateral information storage platform 102. For example, customer device 103 may send the document to collateral information storage platform 102 while the first wireless data connection is established. In some instances, the document may represent a collateral asset, such as a deed to a house, a stock, or any other document that represents ownership of the underlying asset. Although the document is described as relating to a collateral asset, any real-world asset may be used without departing from the scope of the disclosure.

At step 203, collateral information storage platform 102 may receive the document. For example, collateral information storage platform 102 may receive the document via the communication interface 113 and while the first wireless data connection is established. In some instances, instead of customer device 103 sending the document and collateral information storage platform 102 receiving the document, collateral information storage platform 102 may instead use techniques such as generative artificial intelligence to create an AI-generated version of the document without departing from the scope of the disclosure.

At step 204, collateral information storage platform 102 may scan the document that was previously received in step 203. For example, collateral information storage platform 102 may scan the document using scanner and slicer module 112c. Scanning the document may refer to processing information in the document, using, for example, optical character recognition techniques. The scanning performed by collateral information storage platform 102 may further include interpreting the textual information in the document and categorizing portions of information contained in the document, such as categorizing the information according to one or more classification rules. For example, a first rule may be based on a name of an owner of the underlying collateral asset associated with the document. As another example, a second rule may be based on a date in which the owner of the underlying asset associated with the document acquired the collateral asset. In yet another example, a third rule may be a confirmation number associated with the underlying collateral asset.

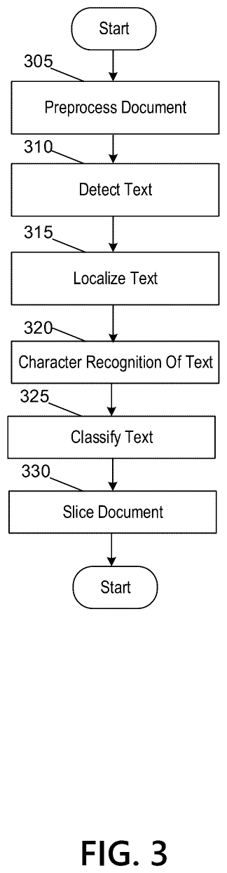

At step 205, collateral information storage platform 102 may slice the document. For example, collateral information storage platform 102 may slice the document using scanner and slicer module 112c. Slicing the document may refer to breaking the document down into one or more sub-portions or slices, based on, for example, the one or more rules that were used to classify information in the document. The scanning and slicing described by steps 204 and 205 may be further described with reference to FIG. 3.

FIG. 3 depicts an illustrative method for scanning and slicing a document in accordance with one or more example aspects described herein. At step 305, a computing platform having at least one processor, a communication interface, and memory may preprocess a document (e.g., that was received from customer device 103). Preprocessing the document may refer to applying techniques such as noise reduction, binarization, and/or skew correction to the document.

At step 310, the computing platform may detect text in the document after preprocessing the document. For example, detecting text may refer to identifying regions in the document where text is present. At step 315, the computing platform may localize the text that was detected at step 310. For example, localizing the text may refer to outlining one or more boundaries associated with each element of text in order to isolate each element of text from the rest of the document.

At step 320, the computing platform may recognize characters of the text that were localized in step 315. For example, optical character recognition (OCR) techniques may be used to recognize individual characters and subsequently convert the characters into machine-readable text.

At step 325, the computing platform may classify the text that was recognized at step 320. For example, the text may be classified based on one or more preconfigured classification rules. For example, a first rule may be based on a name of an owner of the underlying collateral asset associated with the document. As another example, a second rule may be based on a date in which the owner of the underlying asset associated with the document acquired the asset. In yet another example, a third rule may be a confirmation number associated with the underlying collateral asset. One or more additional or alternative rules may be used without departing from the invention.

At step 330, the computing platform may slice the document based on the classification that was performed at step 325. In this manner, sub-portions (i.e., slices) of the document may be created based on the one or more classification rules that were used to classify the text.

Referring back to FIG. 2B, at step 206, collateral information storage platform 102 may apply a watermarking process. The watermarking process may refer to applying mathematical and/or cryptographic operations to the document and the slices of the document in order to generate one or more digital features (i.e., a digital signature) that may be used to securely identify and/or verify the authenticity of the information that corresponds to the document and the slices of the document. In this manner, collateral information storage platform 102 may realize technical benefits related to information security, due to the anti-tampering features created by the watermarking process.

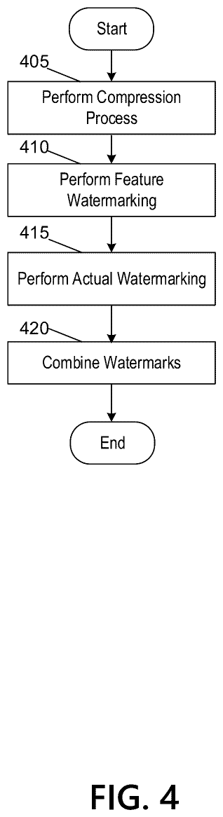

The watermarking process of step 206 may be further described with reference to FIG. 4. FIG. 4 depicts an illustrative method for performing a watermarking process in accordance with one or more example aspects. At step 405, a computing platform having at least one processor, a communication interface, and memory may perform a compression process to the document and the slices of the document. Performing the compression process may refer to applying a mathematical transformation to the document and the slices of the document to create a corresponding sparse image with reduced information. In some instances, the compression process may include encrypting the sparse image using, for example, Rivest-Shamir-Adleman (RSA) encryption or similar techniques may be used. Although described with respect to an RSA encryption algorithm, other homomorphic and/or asymmetric encryption methods (e.g., Diffie-Hellman, Elliptic Curve Cryptography (ECC), or the like) may be used without departing from the scope of the disclosure.

At step 410, the computing platform may perform feature watermarking to the sparse images (corresponding to the document and slices of the document) that were compressed at step 405. For example, feature watermarking may refer to a process of combining row and column vector values of a sparse image to obtain a random feature value, that is used as a feature watermark of the sparse image.

At step 415, the computing platform may perform actual watermarking to the sparse images (corresponding to the document and slices of the document) that were compressed at step 405. For example, actual watermarking may refer to a process of designing and generating a watermark using unique information associated with a user of customer device 103 (e.g., an identification number corresponding to the user).

At step 420, the computing platform may combine the feature and actual watermarking into a final watermark using mathematical and/or cryptographic operations. The final watermark may be, for example, an alphanumeric code that is embedded into the electronic document and/or slices of the electronic document (e.g., a final watermark for the document and/or a final watermark for each slice of the document). In this manner, a multi-layer watermarking process may be applied in order to create a secure proof of authenticity of the information that the watermark corresponds to.

Referring back to FIG. 2B, at step 207, collateral information storage platform 102 may add the watermarked information (e.g., the document and the slices of the document that each corresponding final watermark was embedded into) to a blockchain environment. For example, the watermarked information that corresponds to the document may be stored in mainchain 114 (FIG. 1C). Additionally, the watermarked information that corresponds to the slices of the document may be stored in one or more of sidechain 115, sidechain 116, and/or sidechain 117 (FIG. 1D).

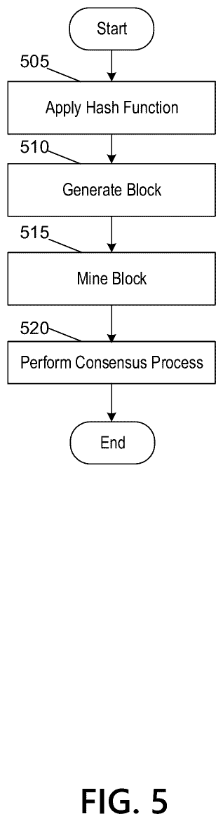

The actions of step 207 may be further described with reference to FIG. 5. FIG. 5 depicts an illustrative method for adding watermarked information to a blockchain environment in accordance with one or more example aspects described herein. At step 505, a computing platform having at least one processor, a communication interface, and memory may apply a hash function to the watermarked information. For example, the hash function may be applied to the document and the slices of the document that were previously watermarked (step 206 of FIG. 2B). In applying the hash function, collateral information storage platform 102 may output a hash value for each of the document and the slices of the document. The hash values may be used in furtherance of generate a corresponding block (step 510).

At step 510, the computing platform may generate a block after applying the hash function to the watermarked information. For example, a block may be generated based on the hash value that was output at step 505 and for each of the document and the slices of the document.

At step 515, the computing platform may mine the block that was generated at step 510 by applying a cryptographic process that solves a computational problem that validates the block. For example, this process may be applied to each block that corresponds to the document and the slices of the document.

At step 520, the computing platform may perform a consensus process to the mined block, which results in the block being added to the blockchain environment module 112e. During this process, a block may be added to mainchain 114 (corresponding to the document), and sidechains 115-117 (corresponding to the slices of the document). In some instances, after the actions of FIG. 5 are performed, a confirmation may be sent to customer device 103, to confirm that the collateral information has been successfully stored in the blockchain environment (e.g., stored in blockchain environment module 112e).

Referring back to FIG. 2B, at step 208, collateral information storage platform 102 may configure a dynamic non-fungible token (DNFT). For example, the DNFT may be configured using the dynamic NFT module 112f. Further, the DNFT may be configured to receive and verify requests for access to collateral information (e.g., information corresponding to the document and slices of the document that were stored in blockchain environment module 112e) from requesting device 104. In some instances, cryptographic logic may be used to configure the DNFT (e.g., public key protocol, authentication protocol/logic, trace model logic, etc).

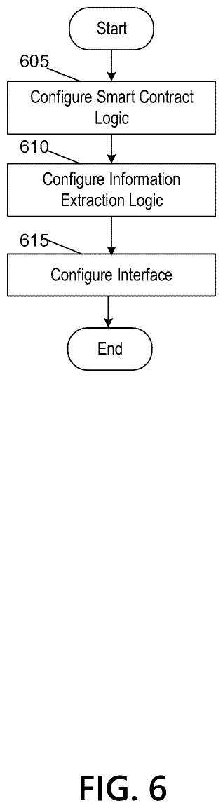

The DNFT configuring of step 208 may be further described with reference to FIG. 6. FIG. 6 depicts an illustrative method for configuring a DNFT in accordance with one or more example aspects. At step 605, a computing platform having at least one processor, a communication interface, and memory may configure smart contract logic, which may be used to define one or more levels of permission to access collateral information stored in blockchain environment module 112e. For example, a user corresponding to customer device 103 may have a first level of permission that enables the user to request access to collateral information associated with the full document and the slices of the document. As another example, an entity corresponding to requesting device 104, may have a second level of permission that enables the entity to request access to collateral information associated with one or more of the slices of the document, but not the full document itself. In this manner, the DNFT may be configured to enable levels of permission to access the collateral information using the smart contract logic.

At step 610, the computing platform may configure information extraction logic. Information extraction logic may be used to enable the DNFT to identify, based on receiving a verified request for access to collateral information, a location of the requested information, and subsequently extract the requested information from blockchain environment module 112e.

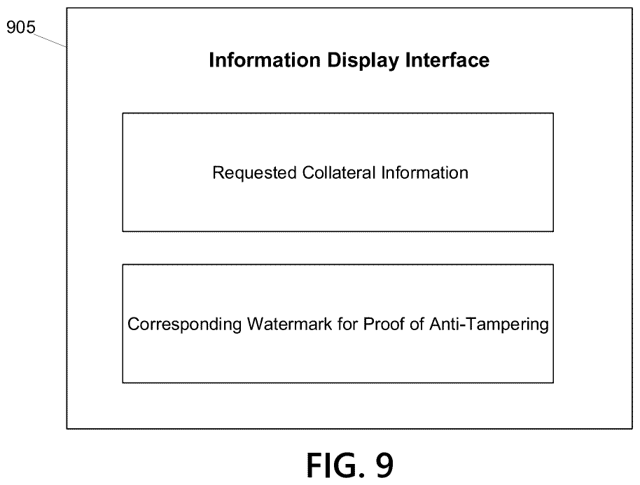

At step 615, the computing platform may configure an interface to display the collateral information that was extracted at step 610 and/or other related information. In some instances, the interface may be similar to the interface 905 shown by FIG. 9. FIG. 9 shows an example interface 905, which may include the requested collateral information, the corresponding watermark, which may be used as proof that the requested collateral information has not been tampered with, and/or other similar information.

Referring back to FIG. 2B, at step 209, requesting device 104 may establish a connection with collateral information storage platform 102. For example, requesting device 104 may establish a second wireless data connection with collateral information storage platform 102 to link requesting device 104 to collateral information storage platform 102 (e.g., in preparation for sending a request for collateral information). In some instances, requesting device 104 may identify whether or not a connection is already established with collateral information storage platform 102. If a connection is already established with collateral information storage platform 102, requesting device 104 might not re-establish the connection. If a connection is not already established with collateral information storage platform 102, requesting device 104 may establish the second wireless data connection as described herein.

Referring to FIG. 2C, at step 210, requesting device 104 may send a request to collateral information storage platform 102. For example, requesting device 104 may send the request to collateral information storage platform 102 while the second wireless data connection is established. For example, the request may be associated with an entity (e.g., a financial institution) that may wish to verify all or some portions of the collateral information that was stored in blockchain environment module 112e (e.g., verify that an individual is the owner of the underlying collateral asset).

At step 211, collateral information storage platform 102 may receive the request that was sent in step 210. For example, collateral information storage platform 102 may receive the request while the second wireless data connection is established and via communication interface 113.

At step 212, collateral information storage platform 102 may validate the request that was sent by requesting device 104. For example, collateral information storage platform 102 may use the DNFT that was configured at step 208 to validate the request by identifying whether or not the requesting device 104 has a level of permission consistent with the level of permission required to access the specific collateral information. If the request is validated, then collateral information storage platform 102 may proceed to step 213 and extract the requested collateral information.

At step 213, collateral information storage platform 102 may, based on validating the request from requesting device 104, use the DNFT to extract the corresponding information from the blockchain environment module 112e. For example, if the requested collateral information corresponds to a slice of the document that was stored at sidechain 115 (FIG. 1C), then the DNFT may extract the requested information stored at sidechain 115.

At step 214, collateral information storage platform 102 may configure an information display interface. For example, the information display interface may show the collateral information that was requested, the final watermark that was created as part of the watermarking process that was performed at step 206, and/or other similar information.

Referring to FIG. 2D, at step 215, collateral information storage platform 102 may send the information display interface to requesting device 104. For example, collateral information storage platform 102 may send the information display interface using the previously established second wireless data connection. In some instances, collateral information storage platform 102 may additionally send commands to requesting device 104 that cause requesting device 104 to display the information display interface.

At step 216, requesting device 104 may receive the information display interface and the commands that were sent at step 215. For example, requesting device 104 may receive the information display interface and the commands while the second wireless data connection is established.

At step 217, requesting device 104 may display the information display interface. For example, the information display interface may be similar to what is shown by FIG. 9. FIG. 9 shows an example interface 905, which may include the requested collateral information, and a corresponding watermark, which may be used as proof that the requested collateral information has not been tampered with. The interface may also show other similar information without departing from the scope of the disclosure.

At step 218, collateral information storage platform 102 may receive a change indication. For example, a change indication may refer to a change regarding any of the collateral information that was previously stored on blockchain environment module 112e, such as a change in ownership of the underlying collateral asset. As another example, a change indication may refer to a change regarding a level of permission associated with an entity, such as requesting device 104. The change indication may be received internally by collateral information storage platform 102, or may be received externally from either of customer device 103 or requesting device 104.

At step 219, collateral information storage platform 102 may perform an update process based on the change indication that was received at step 218. For example, if the change indication relates to a change in the document (e.g., a change of ownership of the underlying collateral asset), then collateral information storage platform 102 may repeat steps 204-208 based on receiving the updated/changed document. As another example, if the change indication relates to changing a level of permission associated with access to the collateral information, then collateral information storage platform 102 may repeat step 208 and configure the DNFT using the new level of permission.

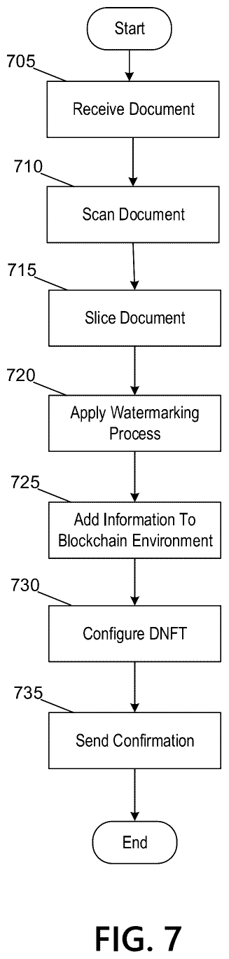

FIG. 7 depicts an illustrative method for securely storing and requesting collateral information in accordance with one or more example aspects described herein. At step 705, a computing platform having at least one processor, a communication interface, and memory may receive a document from a customer device 103. At step 710, the computing platform may scan the document. At step 715, the computing platform may slice the document into one or more portions based on one or more preconfigured classification rules.

At step 720, the computing platform may apply a watermarking process to the document and the slices of the document. At step 725, the computing platform may add the watermarked information to a blockchain environment, which may include a mainchain and one or more sidechains.

At step 730, the computing platform may configure a DNFT to receive requests for collateral information stored in the blockchain environment. At step 735, the computing platform may send a confirmation to the customer device 103.

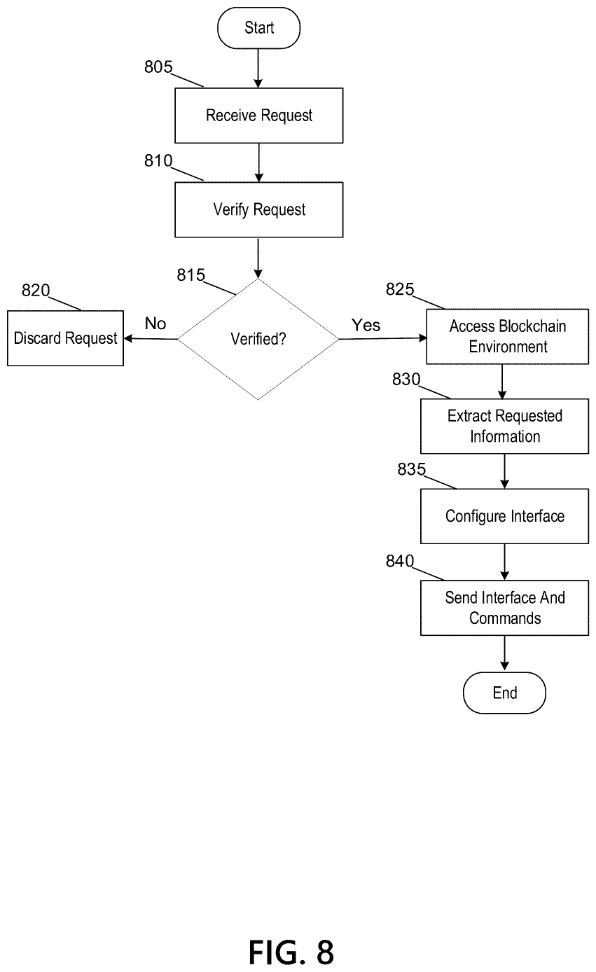

FIG. 8 depicts an illustrative method for securely storing and requesting collateral information in accordance with one or more example aspects described herein. At step 805, a computing platform having at least one processor, a communication interface, and memory may receive a request to access collateral information.

At step 810, the computing platform may verify the request. At step 815, the computing platform may determine whether the request has been verified. If the request is not verified, the method may proceed to step 820 and discard the request. If the request is verified, the method may proceed to step 825.

At step 825, the computing platform may access the blockchain environment in which the collateral information is stored. At step 830, the computing platform may extract the relevant information based on the request.

At step 835, the computing platform may configure an interface (e.g., interface 905 of FIG. 9) to display the requested collateral information. At step 840, the computing platform may send the configured interface to requesting device 104 and commands directing requesting device 104 to display the interface.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive a document from a computing device, wherein the document represents a collateral asset;
scan the document to identify text in the document using an optical character recognition technique;
slice the scanned document into one or more slices that correspond to one or more sub-portions of the identified text in the document;
apply a watermarking process to the scanned document and the one or more slices, to embed an anti-tamper digital signature to the scanned document and the one or more slices;
add, after the watermarking process, the scanned document and the one or more slices to a blockchain environment; and
send a confirmation to the computing device that indicates that the scanned document and the one or more slices were added to the blockchain environment.

2. The computing platform of claim 1, wherein the memory stores computer-readable instructions that, when executed by the at least one processor, further cause the computing platform to:
configure a dynamic non-fungible token (DNFT) to process requests for access to the scanned document or the one or more slices.

3. The computing platform of claim 2, wherein the configuring the DNFT further comprises:
configuring smart contract logic that is used to verify a request for access to the document or the one or more slices of the document;
configuring information extraction logic that is used to identify a location of information associated with the requested; and
configuring an interface to display information that was requested.

4. The computing platform of claim 1, wherein the scanning further comprises:
preprocessing the document;
detecting text in the document;
localizing the text that was detected; and
classifying the text based on one or more classification rules.

5. The computing platform of claim 1, wherein the applying the watermarking process further comprises:
performing a compression process to compress and encrypt the scanned document and the one or more slices;
performing a feature watermarking process to create a feature watermark for the scanned document and the one or more slices;
performing an actual watermarking process to create an actual watermark for the scanned document and the one or more slices; and
combining the feature watermark and the actual watermark to create a final watermark for the scanned document and the one or more slices.

6. The computing platform of claim 1, wherein the blockchain environment further comprises a mainchain and one or more sidechains.

7. The computing platform of claim 6, wherein the scanned document is stored on the mainchain and the one or more slices are stored in the one or more sidechains.

8. The computing platform of claim 1, wherein the memory stores computer-readable instructions that, when executed by the at least one processor, further cause the computing platform to:
receive a change indication that indicates either:
a document update; or
a permission update.

9. The computing platform of claim 8, wherein the memory stores computer-readable instructions that, when executed by the at least one processor, further cause the computing platform to:
based on the change indication being the document update, re-perform the scanning, the slicing, the applying, and the adding using the updated document.

10. The computing platform of claim 8, wherein the memory stores computer-readable instructions that, when executed by the at least one processor, further cause the computing platform to:
based on the change indication being a permission update, update one or more permission levels to access the scanned document or the one or more slices based on the permission update.

11. A method comprising:
at a computing platform comprising at least one processor, a communication interface, and memory:
receiving a document from a computing device, wherein the document represents a collateral asset;
scanning the document to identify text in the document using an optical character recognition technique;
slicing the scanned document into one or more slices that correspond to one or more sub-portions of the identified text in the document;
applying a watermarking process to the scanned document and the one or more slices, to embed an anti-tamper digital signature to the scanned document and the one or more slices;
adding, after the watermarking process, the scanned document and the one or more slices to a blockchain environment; and
sending a confirmation to the computing device that indicates that the scanned document and the one or more slices were added to the blockchain environment.

12. The method of claim 11, further comprising:
configuring a dynamic non-fungible token (DNFT) to process requests for access to the scanned document or the one or more slices.

13. The method of claim 12, wherein the configuring the DNFT further comprises:
configuring smart contract logic that is used to verify a request for access to the document or the one or more slices of the document;
configuring information extraction logic that is used to identify a location of information associated with the requested; and
configuring an interface to display the requested information.

14. The method of claim 11, wherein the scanning further comprises:
preprocessing the document;
detecting text in the document;
localizing the text that was detected; and
classifying the text based on one or more classification rules.

15. The method of claim 11, wherein the applying the watermarking process further comprises:
performing a compression process to compress and encrypt the scanned document and the one or more slices;
performing a feature watermarking process to create a feature watermark for the scanned document and the one or more slices;
performing an actual watermarking process to create an actual watermark for the scanned document and the one or more slices; and
combining the feature watermark and the actual watermark to create a final watermark for the scanned document and the one or more slices.

16. The method of claim 11, wherein the blockchain environment further comprises a mainchain and one or more sidechains.

17. The method of claim 16, wherein the scanned document is stored on the mainchain and the one or more slices are stored in the one or more sidechains.

18. The method of claim 11, further comprising:
receiving a change indication that indicates either:
a document update; or
a permission update.

19. The method of claim 18, further comprising:
based on the change indication being the document update, re-performing the scanning, the slicing, the applying, and the adding using the updated document; and
based on the change indication being a permission update, updating one or more permission levels to access the scanned document or the one or more slices based on the permission update.

20. One or more non-transitory computer-readable media storing instructions that, when executed by a computing platform comprising at least one processor, a communication interface, and memory, cause the computing platform to:
receive a document from a computing device, wherein the document represents a collateral asset;
scan the document to identify text in the document using an optical character recognition technique;
slice the scanned document into one or more slices that correspond to one or more sub-portions of the identified text in the document;
apply a watermarking process to the scanned document and the one or more slices, to embed an anti-tamper digital signature to the scanned document and the one or more slices;
add, after the watermarking process, the scanned document and the one or more slices to a blockchain environment; and
send a confirmation to the computing device that indicates that the scanned document and the one or more slices were added to the blockchain environment.
